(19) United States
(12) Patent Application Publication
(10) Pub. No.: US 2016/0004794 A1
(43) Pub. Date: Jan. 7, 2016

(54) SYSTEM AND METHOD USING GENERATIVE MODEL TO SUPPLEMENT INCOMPLETE INDUSTRIAL PLANT INFORMATION

(71) Applicant: General Electric Company, Schenectady, NY (US)

(72) Inventors: Johan Michael Reimann, Clifton Park, NY (US); Christopher Donald Johnson, Niskayuna, NY (US); Dongrui Wu, Niskayuna, NY (US); Scott Charles Evans, Burnt Hills, NY (US); Richard Edward Kleinhample, Atlanta, GA (US); Achalesh K. Pandey, San Ramon, CA (US)

(21) Appl. No.: 14/322,488

(22) Filed: Jul. 2, 2014

(51) Int. Cl. G06F 17/50; G06F 17/18

(52) U.S. Cl. CPC G06F 17/5004; G06F 17/18

(57) ABSTRACT

According to some embodiments, a model building platform may receive a set of historic industrial plant parameters associated with operation of a plurality of industrial plants over a period of time. The model building platform may automatically create a generative model based on relationships detected within the set of historic industrial plant parameters. A model execution platform may then receive incomplete industrial plant information associated with a particular industrial plant, and automatically generate supplemented industrial plant data based on the received incomplete industrial plant information and the generative model. An indication of the supplemented industrial plant data may then be output.

### BACKGROUND

It can be difficult for an owner of an industrial plant to determine whether the benefits of a contemplated change will, over time, offset the cost of the change. For example, the owner of a power plant that produces electricity may be unsure the cost of a new turbine would result in a sufficient increase in power output to justify that cost. Note that many different factors, such as the type of power plant, the power plant's location, and/or the age of the power plant, may have an impact on such decisions. Moreover, a power plant owner, or a person advising the power plant owner, might only have incomplete information about the operation of the power plant, making such determinations an even more time consuming and error prone task.

It would therefore be desirable to provide systems and methods to supplement incomplete industrial plant information in an automatic and accurate manner.

### BRIEF DESCRIPTION OF THE DRAWINGS

FIG. 1 is a high-level architecture of a system in accordance with some embodiments.

FIG. 2 illustrates a method that might be performed according to some embodiments.

FIG. 3 is block diagram of a model building platform according to some embodiments of the present invention.

FIG. 4 is a tabular portion of a historic industrial plant database according to some embodiments.

FIG. 5 is a tabular portion of a generative model parameters database according to some embodiments.

FIG. 6 is block diagram of a model execution platform according to some embodiments of the present invention.

FIG. 7 is a tabular portion of an incomplete information database according to some embodiments.

FIG. 8 is a tabular portion of a supplemented data database according to some embodiments.

FIG. 9 is a system architecture diagram in accordance with some embodiments.

FIG. 10 is an example of a display that might be provided in accordance with to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

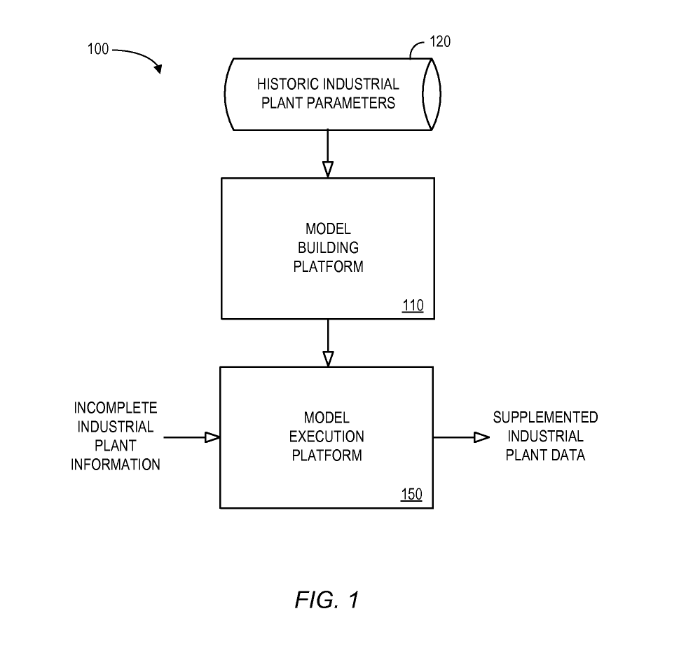

FIG. 1 is a high-level architecture of a system 100 in accordance with some embodiments. The system 100 includes a model building platform 110 that may receive information from a historic industrial plant parameters database 120. The model building platform 110 may, for example, automatically create a generative model based on the received information. As used herein, the term “automatically” may refer to, for example, actions that can be performed with little or no human intervention. The automatically generated model may then be used by a model execution platform 150 to create supplemented industrial plat data based on incomplete industrial plant information.

As used herein, devices, including those associated with the system 100 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The model building platform 110 may receive various types of information, such as a power plant name, plant location, plant age, etc., from the historic industrial plant parameters database 120. The historic industrial plant parameters database 120 may be locally stored or reside remote from the model building platform 110. Although a single model building platform and model execution platform 150 are shown in FIG. 1, any number of such devices may be included. Moreover, various devices described herein might be combined according to embodiments of the present invention. For example, in some embodiments, model building platform 110 and model execution platform 150 might comprise a single apparatus.

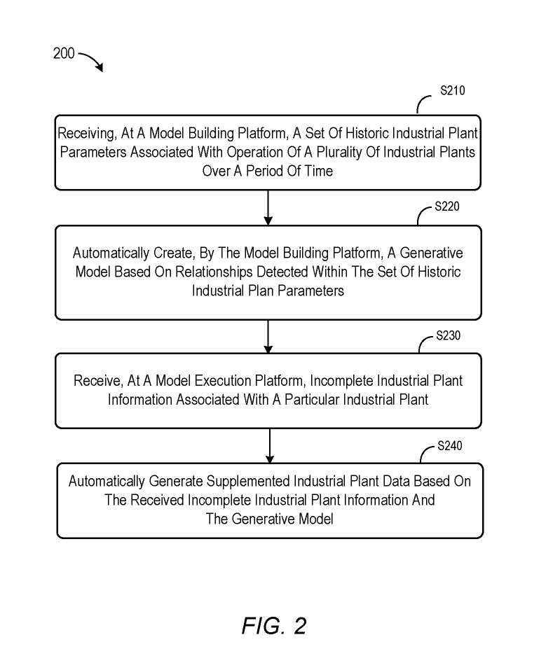

The system 100 may generate supplemented industrial plant data based on received incomplete industrial plant information in an automatic and accurate manner in accordance with any of the embodiments described herein. For example, FIG. 2 illustrates a method 200 that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a model building platform may receive a set of historic industrial plant parameters associated with operation of a plurality of industrial plants over a period of time. As used herein, the phrase “industrial plant” may refer to, for example, a power plant that produces electricity. The set of historic industrial plant parameters might be associated with, for example, economic information (e.g., revenue, costs, or profit), regulatory information, configuration information, and/or operational information.

At S220, the model building platform may automatically create a generative model (e.g., a stochastic generative model) based on relationships detected within the set of historic industrial plant parameters. According to some embodiments, prior to the automatic creation of the generative model, the historic industrial plat parameters may be pre-processed to create normalized data. Note that the automatic creation of the generative model may be associated with a machine deep learning process and a validation test set.

At S230, a model execution platform may receive incomplete industrial plant information associated with a particular industrial plant. At S240, supplemented industrial plant data may be automatically generated based on the received incomplete industrial plant information and the generative model. According to some embodiments, prior to the automatic generation of the supplemented industrial plant information, the historic industrial plant parameters may be pre-processed to create normalized data. Note that the model execution platform may use a Gibbs sampling Markov Chain Monte Carlo (“MCMC”) algorithm to obtain an observation approximated from a specified multivariate probability distribution. According to some embodiments, the incomplete industrial plant information and the supplemented industrial plant data comprise complete industrial plant operational information. Moreover, the supplemented industrial plant data may include likelihood information (e.g., associated with the likely accuracy of the supplemented data). According to some embodiments, an indication of the supplemented industrial plant data may then be output (e.g., to a display, printed report, or web page).

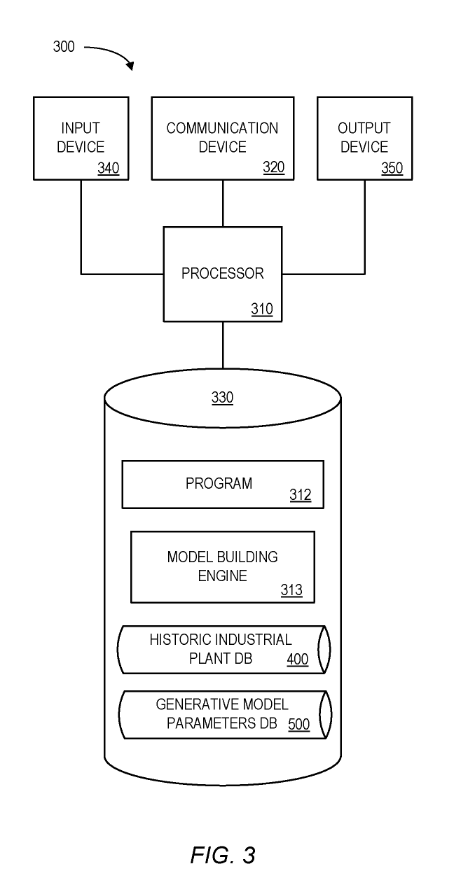

The embodiments described herein may be implemented using any number of different hardware configurations. For example, FIG. 3 is block diagram of a model building platform 300 that may be, for example, associated with the system 100 of FIG. 1. The model building platform 300 comprises a processor 310, such as one or more commercially available Central Processing Units (CPUs) in the form of one-chip microprocessors, coupled to a communication device 320 configured to communicate via a communication network (not shown in FIG. 3). The communication device 320 may be used to communicate, for example, with one or more remote devices (e.g., databases or a model execution engine). The model building platform 300 further includes an input device 340 (e.g., a computer mouse and/or keyboard to input model information) and an output device 350 (e.g., a computer monitor to display results, alerts, scenarios, and/or reports).

The processor 310 also communicates with a storage device 330. The storage device 330 may comprise any appropriate information storage device, including combinations of magnetic storage devices (e.g., a hard disk drive), optical storage devices, mobile telephones, and/or semiconductor memory devices. The storage device 330 stores a program 312 and/or a model building engine 314 for controlling the processor 310. The processor 310 performs instructions of the programs 312, 314, and thereby operates in accordance with any of the embodiments described herein. For example, the processor 310 may access historic industrial plant database 400 storing information about a number of different industrial plants over a period of time. The processor 310 may then automatically create a generative model based on relationships detected within the set of historic industrial plant parameters. The processor 310 may, for example, store generative model parameters, such as weighing factors, in a generative model parameters database 500.

The programs 312, 314 may be stored in a compressed, uncompiled and/or encrypted format. The programs 312, 314 may furthermore include other program elements, such as an operating system, clipboard application a database management system, and/or device drivers used by the processor 310 to interface with peripheral devices.

As used herein, information may be “received” by or “transmitted” to, for example: (i) the model building platform 300 from another device; or (ii) a software application or module within the model building platform 300 from another software application, module, or any other source.

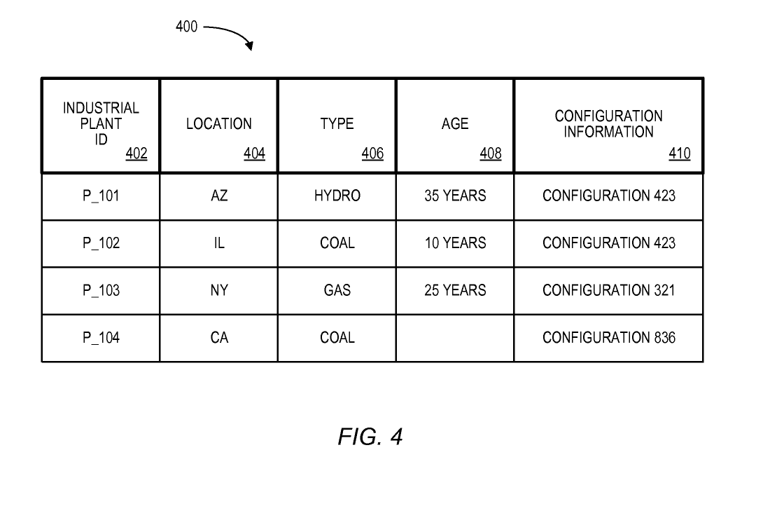

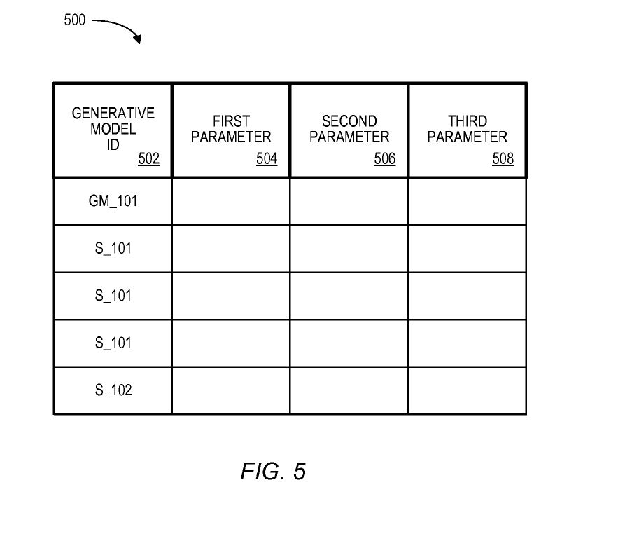

In some embodiments (such as shown in FIG. 3), the storage device 330 stores the historic industrial plant database 400 and the generative model parameters database 500. Examples of databases that may be used in connection with the model building platform 300 will now be described in detail with respect to FIGS. 4 and 5. Note that the databases described herein are only one example, and additional and/or different information may be stored therein. Moreover, various databases might be split or combined in accordance with any of the embodiments described herein.

Referring to FIG. 4, a table is shown that represents the historic industrial plant database 400 that may be stored at the model building platform 300 according to some embodiments. The table may include, for example, entries identifying industrial plants and associated operating characteristics. The table may also define fields 402, 404, 406, 408, 410 for each of the entries. The fields 402, 404, 406, 408, 410 may, according to some embodiments, specify: an industrial plant identifier 402, a location 404, a type 406, an age 408, and configuration information 410. The historic industrial plant database 400 may be created and updated, for example, when industrial plants are created, operated, and/or as component are added to or removed from an industrial plant, etc.

The industrial plant identifier 402 may be, for example, unique alphanumeric codes identifying industrial plants, such as power plants that produce electricity. Note that a single plant might be associated with multiple entries (e.g., representing an output of a power plant over different periods of time). The location 404 might indicate a country or state where the power plant is location, and the type 406 might indicate how each plant produces electricity (e.g., via gas or coal). The age 408 may indicate how long the plant has been in operation, and configuration information 410 might be associated with any operational characteristic of the power plant (e.g., a number of turbines, a maintenance schedule, a pre-stored configuration profile, etc.). Note that some of the information in the historic industrial plant database 400 may be missing (e.g., the age 408 of the power plant “P_104” is unknown and therefore blank).

Note that the information in the example of FIG. 4 is greatly simplified for clarity, and many other types of data might be stored in the database 400. For example, plant location and/or regulatory information could include a country name and a market identifier used in locations where there may be multiple different markets. The configuration information 410 could include information about single cycle, combined cycle, what type of gas turbine are used, and/or base or peak load operators. Other examples of operational information might include compressor efficiency, a corrected heat rate (corrected to “standard day”, i.e. sea level pressure and fixed temperature), a turbine efficiency, power plant output, startup reliability, operational reliability, fuel price, on and off peak spark spreads, etc.

Referring to FIG. 5, a table is shown that represents the generative model parameters database 500 that may be stored at the model building platform 300 according to some embodiments. The table may include, for example, entries identifying generative models. The table may also define fields 502, 504, 506, 508 for each of the entries. The fields 502, 504, 506, 508 may, according to some embodiments, specify: a generative model identifier 502 and associated parameters 504, 506, 508. The generative model parameters database 500 may be created and updated, for example, by a model building platform.

The generative model identifier 502 may be, for example, unique alphanumeric codes identifying a generative model and the parameters 504, 506, 508 may be associated with weighing values, rules, and/or any other information that may be used to define the model. As used herein, the phrase “generative model” may refer to a model for randomly generating observable data, such as when fed some parameters. It may specify a joint probability distribution over observation and/or label sequences. The generative model may be associated with machine learning, modeling data directly (such as when modeling observations drawn from a probability density function), and/or as an intermediate step to forming a conditional probability density function. A conditional distribution might be formed for example, from a generative model through Bayes' rule.

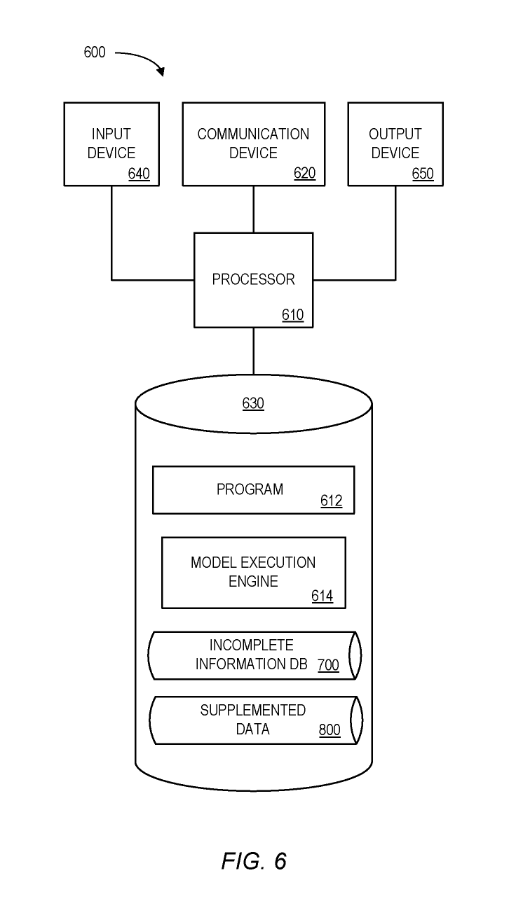

The information in the generative model parameters database 500 may then be used by a model execution platform. For example, FIG. 6 is block diagram of a model execution platform 600 that may be, for example, associated with the system 100 of FIG. 1. The model execution platform 600 comprises a processor 610, such as one or more commercially available CPUs in the form of one-chip microprocessors, coupled to a communication device 620 configured to communicate via a communication network (not shown in FIG. 6). The communication device 620 may be used to communicate, for example, with one or more remote devices (e.g., databases or a model building engine). The model execution platform 600 further includes an input device 640 (e.g., a computer mouse and/or keyboard to input industrial plant information) and an output device 650 (e.g., a computer monitor to display results, alerts, scenarios, and/or reports).

The processor 610 also communicates with a storage device 630. The storage device 630 may comprise any appropriate information storage device, including combinations of magnetic storage devices (e.g., a hard disk drive), optical storage devices, mobile telephones, and/or semiconductor memory devices. The storage device 630 stores a program 612 and/or a model execution engine 614 for controlling the processor 610. The processor 610 performs instructions of the programs 612, 614, and thereby operates in accordance with any of the embodiments described herein. For example, the processor 610 may access an incomplete information database 700 storing information about one or more industrial plants. The processor 610 may then execute a generative model and store supplemented data in a supplemented data database 800.

The programs 612, 614 may be stored in a compressed, uncompiled and/or encrypted format. The programs 612, 614 may furthermore include other program elements, such as an operating system, clipboard application a database management system, and/or device drivers used by the processor 610 to interface with peripheral devices.

As used herein, information may be “received” by or “transmitted” to, for example: (i) the model execution platform 600 from another device; or (ii) a software application or module within the model execution platform 600 from another software application, module, or any other source.

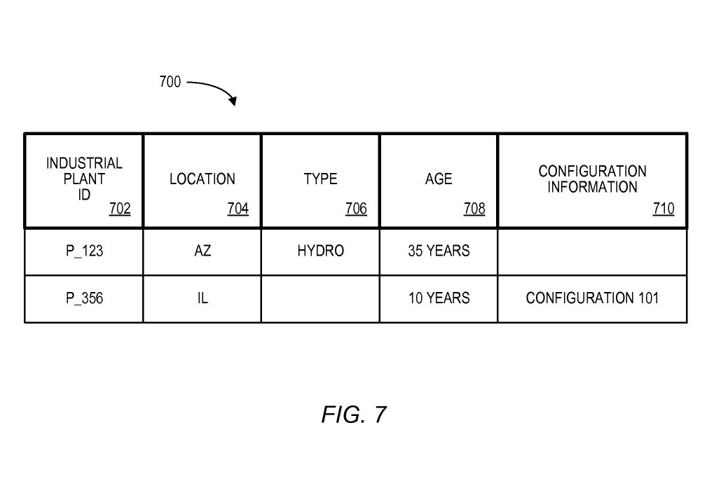

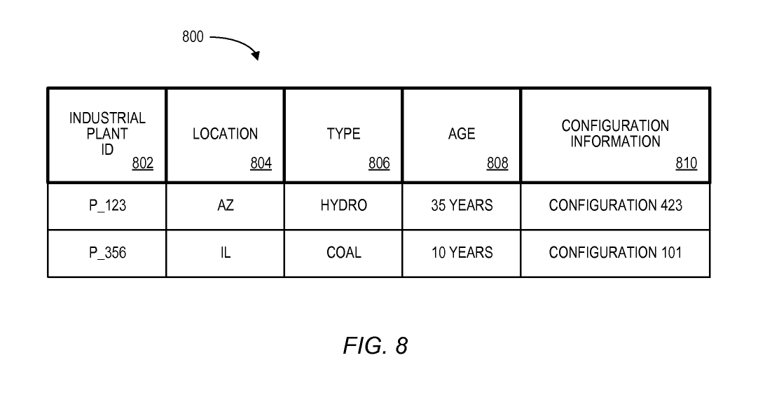

In some embodiments (such as shown in FIG. 6), the storage device 630 stores the incomplete information database 700 and the supplemented data database 800. Examples of databases that may be used in connection with the model execution platform 600 will now be described in detail with respect to FIGS. 7 and 8. As before, the databases described herein are only one example, and additional and/or different information may be stored therein. Moreover, various databases might be split or combined in accordance with any of the embodiments described herein.

Referring to FIG. 7, a table is shown that represents the incomplete information database 700 that may be stored at the model execution platform 600 according to some embodiments. The table may include, for example, entries identifying one or more industrial plants. The table may also define fields 702, 704, 706, 708, 710 for each of the entries. The fields 702, 704, 706, 708, 710 may, according to some embodiments, specify: an industrial plant identifier 702, a location 704, a type 706, an age 708, and configuration information 710. The incomplete information database 700 may be created and updated, by a system operator or may be automatically submitted to the system.

The industrial plant identifier 702 may be, for example, unique alphanumeric codes identifying industrial plants, such as power plants that produce electricity. The location 704 might indicate a country or state where the power plant is location, and the type 706 might indicate how each plant produces electricity (e.g., via gas or coal). The age 708 may indicate how long the plant has been in operation, and configuration information 710 might be associated with any operational characteristic of the power plant (e.g., a number of turbines, a maintenance schedule, a pre-stored configuration profile, etc.). Note that the information in the database is “incomplete” (e.g., the configuration information 710 for “P_123” and the type 704 for “P_356” are unknown and therefore blank).

Referring to FIG. 8, a table is shown that represents the supplemented data database 800 that may be stored at the model execution platform 600 according to some embodiments. The table may include, for example, entries similar to those in the incomplete information database 700. That is the table may define fields 802, 804, 806, 808 for each of the entries and the fields 802, 804, 806, 808 may, according to some embodiments, specify: an industrial plant identifier 802, a location 804, a type 806, an age 808, and configuration information 810. The supplemented data database 800 may be created and updated, for example, based on the output of a generative model.

Note that the information in the database 800 is “supplemented” such that the blank values from the incomplete information database have been filled in. For example, the configuration information 810 for “P_123” and the type 804 for “P_356” have been determined by the generative model and stored into the database 800.

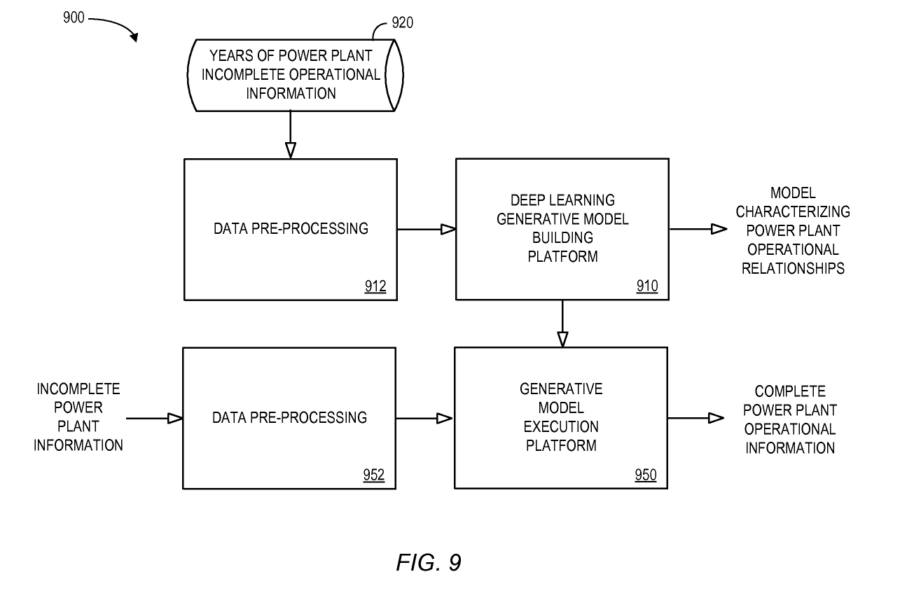

FIG. 9 is a system architecture diagram 900 in accordance with some embodiments. The system 900 includes a deep learning generative model building platform 110 that may receive information from years of power plant incomplete operational information database 920 via data pre-processing 912 (e.g., to create normalized parameters). The model building platform 910 may, for example, automatically create a generative model based on the received information. The automatically generated model may then be used by a generative model execution platform 950 to create supplemented industrial plat data based on incomplete power plant information received via data pre-processing 952 (e.g., to create normalize parameters.

Such a system 900, including algorithms and enabling software, may estimate the power plant operational characteristics given the incomplete plant information. The system 900 may be “big data” based and may be a part of an industrial internet initiative. The system 900 may use a large number of power plant examples and deep learning techniques to extract and describe the relationships between various power plant economic, regulatory, configuration, and/or operational information. These relationships may be captured in a stochastic generative model which may be used to impute the missing information about a particular plant.

The complete information from the system 900 may be used to assess configuration and/or modification needs for a power plant and ultimately improve the plant's performance given the economic environment in which it operates. According to some embodiments, the system 900 may be extended to other applications where missing data impedes operations, such as automated maintenance record correction and completion and/or user preference inference.

According to some embodiments, the system 900 includes two process steps. The first step is training a deep learning module. That may include accessing a database containing historical data used to train the model. Note that the information in the database might not be complete, that is, the system 900 may learn from incomplete plant economic, configuration, and/or operational information. According to some embodiments, continuous, numeric categorical, and string categorical data is pre-processed and normalize to facilitate processing. A deep learning algorithm may process the historical data and capture the relationships observed in the data. Once the model is generated, it may be validated using a validation test set.

The second process step associated with the system 900 is model execution. That may include, given a new incomplete record, a generative model may be sampled using Gibbs sampling. The output may provide the maximum likelihood, along with other statistical parameters such as the standard deviation. This may let a user assess the output's precision. According to some embodiments, the system 900 may also be used to compare the current performance of a power plant to an average of power plants with the same or similar configurations and/or economic environments. This may help a user assess if the plant should be operated or configured differently. Note that, according to some embodiments, the system 900 may be used to study the effect of individual customization and/or modifications on a specific plant such that a quantifiable benefit may be derived and used to recommend highly effective changes.

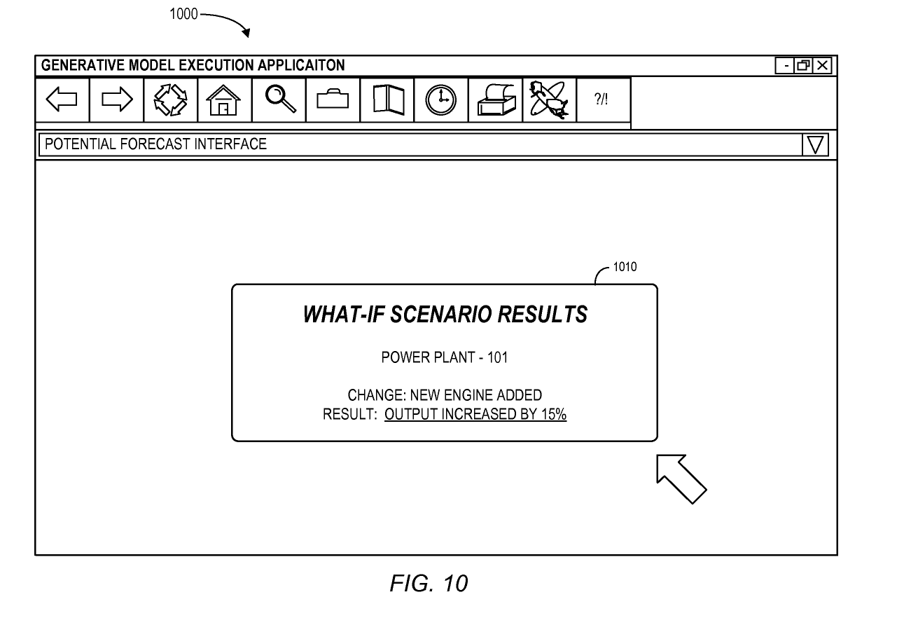

According to some embodiments, the system 900 may help a user obtain a complete picture of operational needs to help a power plant operate optimally given the plant configuration and economic environment. Moreover, the system 900 may provide an ability to gain insight into user behavior and identify value-drivers using deep learning techniques. In addition, the system 900 may provide statistical information that can be used to guide future data collection efforts. For example, the system 900 may be associated with a means to identify observations for which eliminating uncertainty may provide a measurable benefit in terms of assessing plan operations. FIG. 10 is an example of a display 1000 that might be provided to a user when a he or she proposes a change to a power plant in accordance with to some embodiments. In particular, the display 1000 includes a “what-if” scenario result 1010 indicating how the change may impact the power plant.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method, comprising:
receiving, at a model building platform, a set of historic industrial plant parameters associated with operation of a plurality of industrial plants over a period of time;
automatically creating, by the model building platform, a generative model based on relationships detected within the set of historic industrial plant parameters;
receiving, at a model execution platform, incomplete industrial plant information associated with a particular industrial plant;
automatically generating supplemented industrial plant data based on the received incomplete industrial plant information and the generative model; and
outputting an indication of the supplemented industrial plant data.

2. The method of claim 1, wherein the industrial plants comprise power plants that produce electricity.

3. The method of claim 1, wherein the set of historic industrial plant parameters are associated with at least one of: (i) economic information, (ii) regulatory information, (iii) configuration information, and (iv) operational information.

4. The method of claim 1, further comprising:
prior to the automatic creation of the generative model, pre-processing the historic industrial plat parameters to create normalized data.

5. The method of claim 4, wherein the automatic creation of the generative model is associated with a machine deep learning process and a validation test set.

6. The method of claim 1, further comprising:
prior to the automatic generation of the supplemented industrial plant data, pre-processing the received incomplete industrial plant information to created normalized data.

7. The method of claim 1, wherein the generative model comprises a stochastic generative model.

8. The method of claim 7, wherein the model execution platform uses a Gibbs sampling Markov Chain Monte Carlo algorithm to obtain an observation approximated from a specified multivariate probability distribution.

9. The method of claim 1, wherein the incomplete industrial plant information and the supplemented industrial plant data comprise complete industrial plant operational information.

10. The method of claim 9, wherein the supplemented industrial plant data includes likelihood information.

11. A non-transitory, computer-readable medium storing instructions that, when executed by a computer processor, cause the computer processor to perform a medium, the medium comprising:
receiving, at a model building platform, a set of historic industrial plant parameters associated with operation of a plurality of industrial plants over a period of time;
automatically creating, by the model building platform, a generative model based on relationships detected within the set of historic industrial plant parameters;
receiving, at a model execution platform, incomplete industrial plant information associated with a particular industrial plant;
automatically generating supplemented industrial plant data based on the received incomplete industrial plant information and the generative model; and
outputting an indication of the supplemented industrial plant data.

12. The medium of claim 11, wherein the industrial plants comprise power plants that produce electricity, and the set of historic industrial plant parameters are associated with at least one of: (i) economic information, (ii) regulatory information, (iii) configuration information, and (iv) operational information.

13. The medium of claim 1, wherein execution of the instructions further results in:
prior to the automatic creation of the generative model, pre-processing the historic industrial plat parameters to create normalized data, and the automatic creation of the generative model is associated with a machine deep learning process and a validation test set; and
prior to the automatic generation of the supplemented industrial plant data, pre-processing the received incomplete industrial plant information to created normalized data.

14. The medium of claim 11, wherein the generative model comprises a stochastic generative model and the model execution platform uses a Gibbs sampling Markov Chain Monte Carlo algorithm to obtain an observation approximated from a specified multivariate probability distribution.

15. The medium of claim 11, wherein the incomplete industrial plant information and the supplemented industrial plant data comprise complete industrial plant operational information, and the supplemented industrial plant data includes likelihood information.

16. A system, comprising:
a database storing a set of historic industrial plant parameters associated with operation of a plurality of industrial plants over a period of time;
a model building platform coupled to the database to: receive the set of historic industrial plant parameters, and automatically create a generative model based on relationships detected within the set of historic industrial plant parameters; and
a model execution platform to: receive incomplete industrial plant information associated with a particular industrial plant, automatically generate supplemented industrial plant data based on the received incomplete industrial plant information and the generative model, and output an indication of the supplemented industrial plant data.

17. The system of claim 16, wherein the industrial plants comprise power plants that produce electricity, and the set of historic industrial plant parameters are associated with at least one of: (i) economic information, (ii) regulatory information, (iii) configuration information, and (iv) operational information.

18. The system of claim 16, wherein:
the model building platform is further to, prior to the automatic creation of the generative model, pre-process the historic industrial plat parameters to create normalized data, and the automatic creation of the generative model is associated with a machine deep learning process and a validation test set; and
the model execution platform is further to, prior to the automatic generation of the supplemented industrial plant data, pre-process the received incomplete industrial plant information to created normalized data.

19. The system of claim 16, wherein the generative model comprises a stochastic generative model and the model execution platform uses a Gibbs sampling Markov Chain Monte Carlo algorithm to obtain an observation approximated from a specified multivariate probability distribution.

20. The system of claim 16, wherein the incomplete industrial plant information and the supplemented industrial plant data comprise complete industrial plant operational information, and the supplemented industrial plant data includes likelihood information.
